(19) United States
(12) Patent Application Publication
(10) Pub. No.: US 2007/0046662 A1
(43) Pub. Date: Mar. 1, 2007

(54) Authentication apparatus and authentication method

(75) Inventors: Yuichi Kawakami, Nishinomiya-shi (JP); Yuusuke Nakano, Nagoya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/507,351

(22) Filed: Aug. 21, 2006

(30) Foreign Application Priority Data
Aug. 23, 2005 (JP) JP2005-241034

(51) Int. Cl. G06T 15/00

(52) U.S. Cl. 345/419

(57) ABSTRACT

An authentication apparatus comprises a first acquiring part for acquiring three-dimensional shape information of a face of a target person to be authenticated, a compressing part for compressing said three-dimensional shape information by using a predetermined mapping relation, thereby generating three-dimensional shape feature information, and an authenticating part for performing an operation of authenticating said target person by using said three-dimensional shape feature information. When a vector space expressing said three-dimensional shape information is virtually separated into a first subspace in which the influence of a change in facial expression is relatively small and which is suitable for discrimination among persons and a second subspace in which the influence of a change in facial expression is relatively large and which is not suitable for discrimination among persons, said predetermined mapping relation is decided so as to transform an arbitrary vector in said vector space into a vector in said first subspace.

This application is based on application No. 2005-241034 filed in Japan, the contents of which are hereby incorporated by reference.

### BACKGROUND OF THE INVENTION

1. Field of the Invention

The present invention relates to a technique for authenticating a face.

2. Description of the Background Art

In recent years, various electronic services are being spread with development in the network techniques and the like, and the non-face-to-face personal authentication techniques are in increasing demand. To address the demand, the biometric authentication techniques for automatically identifying a person on the basis of biometric features of the person are being actively studied. The face authentication technique as one of the biometric authentication techniques is a non-face-to-face authentication method and is expected to be applied to various fields of security with a monitor camera, an image database using faces as keys, and the like.

At present, a method is proposed realizing improvement in authentication accuracy by using a three-dimensional shape of a face as supplementary information for authentication in an authentication method using two-dimensional information obtained from a face image (refer to Japanese Patent Application Laid-Open No. 2004-126738).

The method, however, has a problem such that since changes in information caused by the influence of a change in facial expression of a person to be authenticated and the like are not considered in the three-dimensional shape information (hereinafter, also referred to as three-dimensional information) or two-dimensional information obtained from the person to be authenticated, the authentication accuracy is not sufficiently high.

### SUMMARY OF THE INVENTION

An object of the present invention is to provide a technique capable of performing authentication at higher accuracy as compared with the case of performing authentication using authentication information as it is, which is obtained from a person to be authenticated.

In order to achieve this object, an authentication apparatus of the present invention includes: a first acquiring part for acquiring three-dimensional shape information of a face of a target person to be authenticated; a compressing part for compressing the three-dimensional shape information by using a predetermined mapping relation, thereby generating three-dimensional shape feature information; and an authenticating part for performing an operation of authenticating the target person by using the three-dimensional shape feature information. When a vector space expressing the three-dimensional shape information is virtually separated into a first subspace in which the influence of a change in facial expression is relatively small and which is suitable for discrimination among persons and a second subspace in which the influence of a change in facial expression is relatively large and which is not suitable for discrimination among persons, the predetermined mapping relation is decided so as to transform an arbitrary vector in the vector space into a vector in the first subspace.

Since the authentication apparatus compresses three-dimensional shape information of the face of a person to be authenticated to three-dimensional shape feature information in which the influence of a change in the facial expression is relatively small and which is suitable for discrimination among persons by using a predetermined mapping relation and performs the authenticating operation by using the three-dimensional shape feature information. Thus, authentication which is not easily influenced by a change in facial expression can be performed.

Further, the present invention is also directed to an authentication method and a computer software program.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram showing an example of applying a face authentication system according to a preferred embodiment of the present invention;

FIG. 2 is a diagram showing a schematic configuration of a controller;

FIG. 3 is a block diagram showing various functions of the controller;

FIG. 4 is a block diagram showing a detailed functional configuration of a person authenticating part;

FIG. 5 is a block diagram showing a further detailed functional configuration of an image normalizing part;

FIG. 6 is a flowchart showing authenticating operation;

FIG. 7 is a diagram showing feature points of a characteristic part in a face image;

FIG. 8 is a schematic diagram for calculating three-dimensional coordinates from feature points in a two-dimensional image;

FIG. 9 is a diagram showing a standard model of a three-dimensional face;

FIG. 10 is a conceptual diagram showing normalization of texture information in predetermined patches;

FIG. 11 is a diagram showing texture information;

FIG. 12 is a flowchart showing dictionary generating operation;

FIG. 13 is a schematic diagram showing a projection state of three-dimensional shape information;

FIG. 14 is a schematic diagram showing a projection state of three-dimensional shape information;

FIG. 15 is a schematic diagram showing a projection state of three-dimensional shape information;

FIG. 16 is a schematic diagram showing a projection state of three-dimensional shape information;

FIG. 17 is a diagram showing individual control points of a characteristic part after normalization;

FIG. 18 is a flowchart showing registering operation;

FIG. 19 is a diagram showing a straight line connecting individual control points;

FIG. 20 is a diagram showing a triangle formed by three individual control points; and

FIG. 21 is a diagram showing a three-dimensional shape measuring device constructed by a laser beam emitter and a camera.

### DESCRIPTION OF THE PREFERRED EMBODIMENT

A preferred embodiment of the present invention will be described below with reference to the drawings.

### Preferred Embodiment

Outline

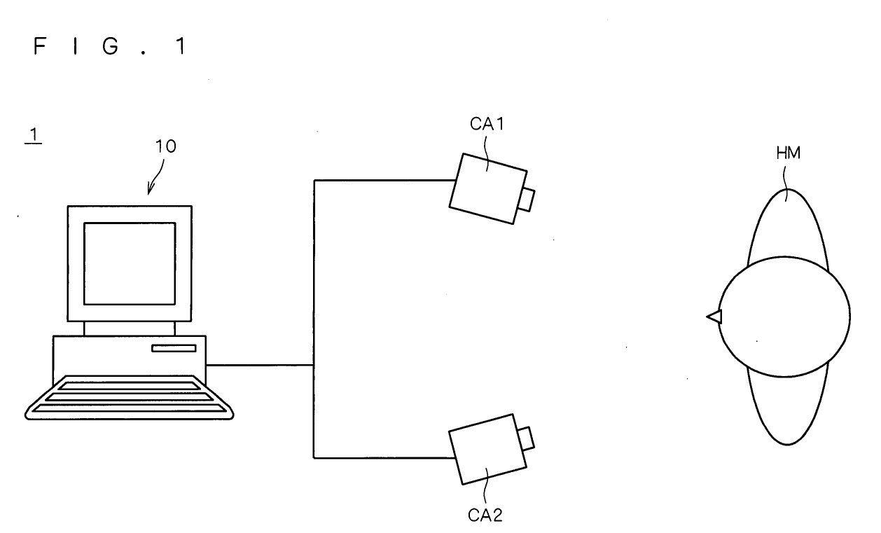

FIG. 1 is a configuration diagram showing a face authentication system 1 according to a preferred embodiment of the present invention. As shown in FIG. 1, the face authentication system 1 is constructed by a controller 10 and two image capturing cameras (hereinafter, also simply referred to as “cameras”) CA1 and CA2. The cameras CA1 and CA2 are disposed so as to be able to capture images of the face of a person HM to be authenticated from different positions. When face images of the person HM to be authenticated are captured by the cameras CA1 and CA2, appearance information, specifically, two kinds of face images of the person HM to be authenticated captured by the image capturing operation is transmitted to the controller 10 via a communication line. The communication method for image data between the cameras and the controller 10 is not limited to a wired method but may be a wireless method.

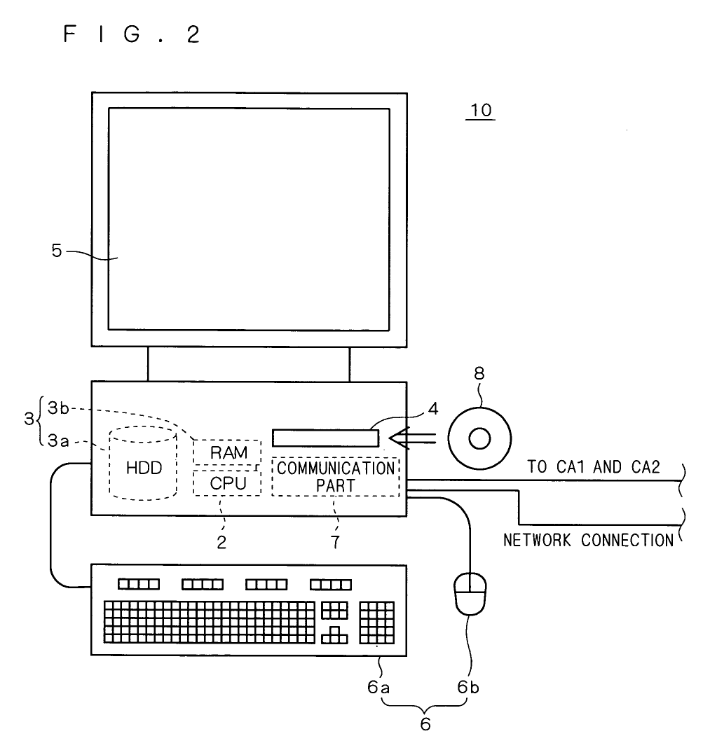

FIG. 2 is a diagram showing a schematic configuration of the controller 10. As shown in FIG. 2, the controller 10 is a general computer such as a personal computer including a CPU 2, a storage 3, a media drive 4, a display 5 such as a liquid crystal display, an input part 6 such as a keyboard 6a and a mouse 6b as a pointing device, and a communication part 7 such as a network card. The storage 3 has a plurality of storing media, concretely, a hard disk drive (HDD) 3a and a RAM (semiconductor memory) 3b capable of performing processes at a higher speed than the HDD 3a. The media drive 4 can read information recorded on a portable recording medium 8 such as CD-ROM, DVD (Digital Versatile Disk), flexible disk, or memory card. The information supplied to the controller 10 is not limited to information supplied via the recording medium 8 but may be information supplied via a network such as LAN or the Internet.

Next, various functions of the controller 10 will be described.

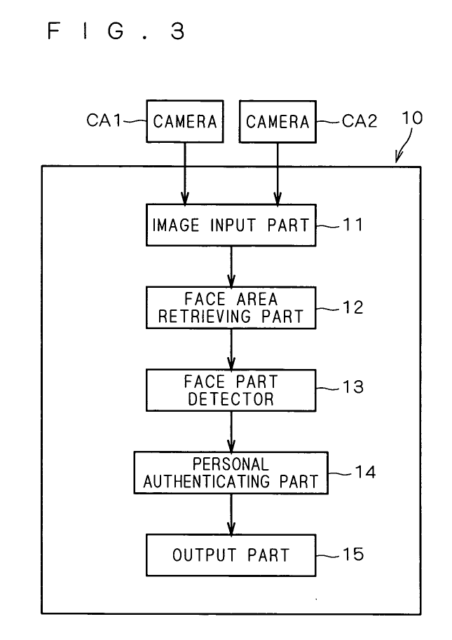

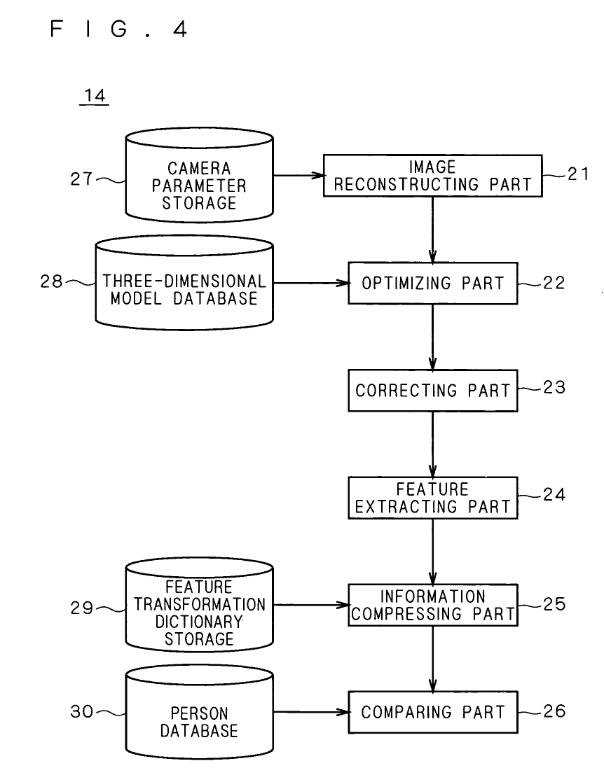

FIG. 3 is a block diagram showing the various functions of the controller 10. FIG. 4 is a block diagram showing a detailed functional configuration of a personal authenticating part 14.

The various functions of the controller 10 are conceptual functions realized by executing a predetermined software program (hereinafter, also simply referred to as “program”) with various kinds of hardware such as the CPU in the controller 10.

As shown in FIG. 3, the controller 10 has an image input part 11, a face area retrieving part 12, a face part detector 13, the personal authenticating part 14, and an output part 15.

The image input part 11 has the function of inputting two images captured by the cameras CA1 and CA2 to the controller 10.

The face area retrieving part 12 has the function of specifying a face part in an input face image.

The face part detector 13 has the function of detecting the positions of characteristic parts (for example, eyes, eyebrows, nose, mouth, and the like) in the specified face area.

The personal authenticating part 14 is constructed to mainly authenticate a face and has the function of authenticating a person on the basis of a face image. The details of the personal authenticating part 14 will be described later.

The output part 15 has the function of outputting an authentication result obtained by the personal authenticating part 14.

Next, the detailed configuration of the personal authenticating part 14 will be described with reference to FIG. 4.

As shown in FIG. 4, the person authenticating part 14 has a three-dimensional reconstructing part 21, an optimizing part 22, a correcting part 23, a feature extracting part 24, an information compressing part 25, and a comparing part 26.

The three-dimensional reconstructing part 21 has the function of calculating coordinates in three dimensions of each part from coordinates of a characteristic part of a face obtained from an input image. The three-dimensional coordinate calculating function is realized by using camera information stored in a camera parameter storage 27.

The optimizing part 22 has the function of generating an individual model from a standard stereoscopic model of a face stored in a three-dimensional database 28 (also simply referred to as “standard stereoscopic model” or “standard model”) by using the calculated three-dimensional coordinates.

The correcting part 23 has the function of correcting the generated individual model.

By the processing parts 21, 22, and 23, information of the person HM to be authenticated is normalized and converted to information which can be easily compared. The individual model generated by the function of the processing parts includes both three-dimensional information and two-dimensional information of the person HM to be authenticated. The “three-dimensional information” is information related to a stereoscopic configuration constructed by three-dimensional coordinate values or the like. The “two-dimensional information” is information related to a plane configuration constructed by surface information (texture information) and/or information of positions in a plane or the like.

The feature extracting part 24 has a feature extracting function of extracting the three-dimensional information and two-dimensional information from the individual model generated by the processing parts 21, 22, and 23.

The information compressing part 25 has the function of compressing each of the three-dimensional information and the two-dimensional information used for face authentication by converting each of the three-dimensional information and the two-dimensional information extracted by the feature extracting part 24 to a proper face feature amount for face authentication. The information compressing function is realized by using information stored in a feature transformation dictionary storage 29 and the like.

The comparing part 26 has the function of calculating similarity between a face feature amount of a registered person (person to be compared), which is pre-registered in a person database 30 and a face characteristic amount of the person HM to be authenticated, which is obtained by the above-described function parts, thereby authenticating the face.

In the following, the operations realized by the functions of the controller 10 will be described.

Operations

First, the general operations of the controller 10 will be described.

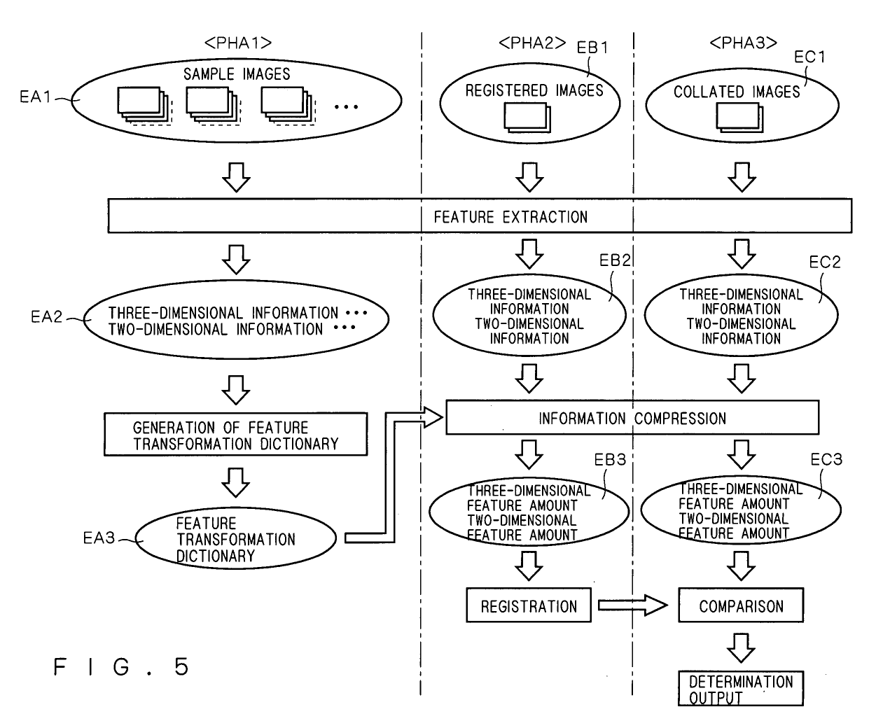

FIG. 5 is a diagram showing general operations of the controller 10. As shown in FIG. 5, the operations of the controller 10 can be divided into a dictionary generating operation PHA1, a registering operation PHA2, and an authenticating operation PHA3 in accordance with purposes.

In the dictionary generating operation PHA1, three-dimensional information and two-dimensional information EA2 is extracted from each of a plurality of sample face images EA1. On the basis of a plurality of pieces of three-dimensional information and two-dimensional information, a feature transformation dictionary EA3 is generated. The generated feature transformation dictionary EA3 is stored in the feature transformation dictionary storage 29.

In the registering operation PHA2, three-dimensional information and two-dimensional information EB2 obtained from a registered image EB1 is compressed by using the feature transformation dictionary EA3, thereby acquiring three-dimensional and two-dimensional feature amounts EB3. The acquired three-dimensional and two-dimensional feature amounts EB3 are registered as registered face feature amounts in the person database 30

In the authenticating operation PHA3, three-dimensional and two-dimensional information EC2 obtained from a collated image EC1 is compressed by using the feature transformation dictionary EA3, thereby acquiring the three-dimensional and two-dimensional feature amounts EB3. The three-dimensional and two-dimensional feature amounts EB3 in the collated image EC1 are compared with registered face feature amounts registered in the person database 30.

As described above, in the controller 10, the registering operation PHA2 is executed by using the feature transformation dictionary EA3 obtained by the dictionary generating operation PHA1, and the authenticating operation PHA3 is executed by using the registered face feature amounts obtained by the registering operation PHA2.

In the following, assuming that the dictionary generating operation PHA1 and the registering operation PHA2 have been finished, the authenticating operation PHA3 will be described.

Concretely, the case of performing the face authentication (the authenticating operation PHA3) of a predetermined person whose face is photographed by the cameras CA1 and CA2 as the person HM to be authenticated will be described. In this case, three-dimensional shape information measured on the basis of the principle of triangulation by using images captured by the cameras CA1 and CA2 is used as the three-dimensional information, and texture (brightness) information is used as the two-dimensional information.

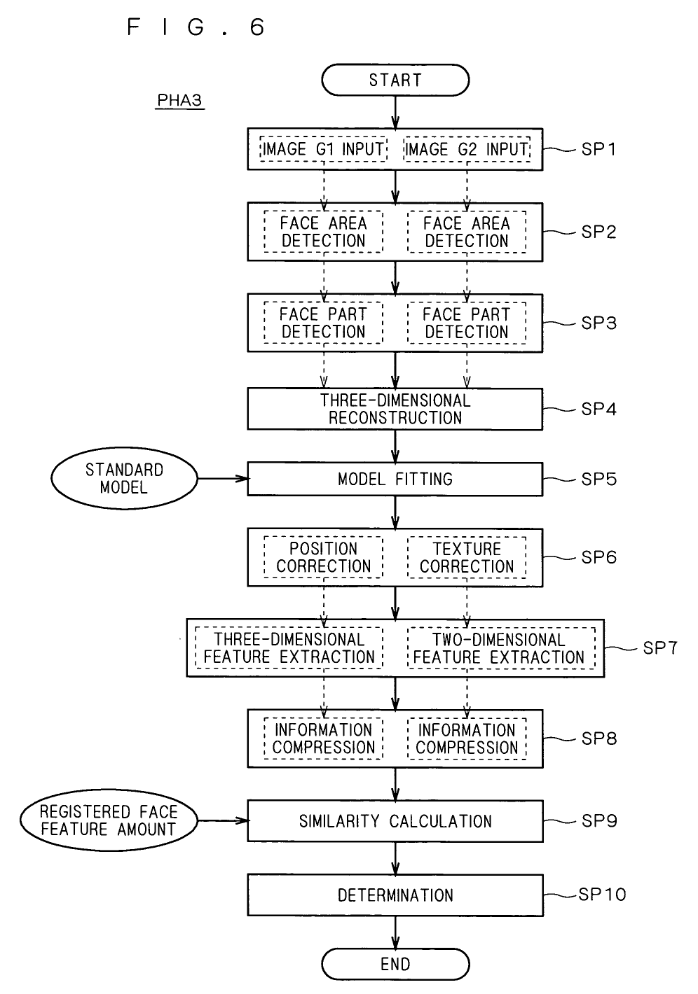

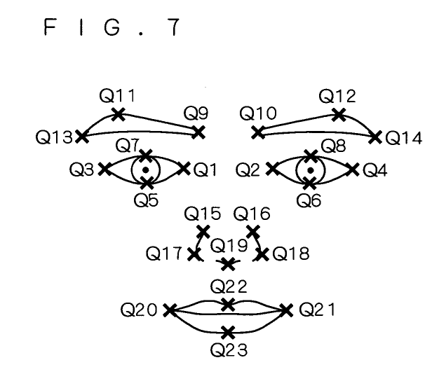

FIG. 6 is a flowchart of the authenticating operation PHA3 of the controller 10. FIG. 7 is a diagram showing feature points of a feature part in a face image. FIG. 8 is a schematic diagram showing a state where three-dimensional coordinates are calculated by using the principle of triangulation from feature points in two-dimensional images. Reference numeral G1 in FIG. 8 denotes an image G1 captured by the camera CA1 and input to the controller 10. Reference numeral G2 denotes an image G2 captured by the camera CA2 and input to the controller 10. Points Q20 in the images G1 and G2 correspond to the right end of a mouth in FIG. 7.

As shown in FIG. 6, the controller 10 acquires a face feature amount of the person HM to be authenticated on the basis of captured images of the face of the person HM to be authenticated in the processes from step SP1 to step SP8. Further, by performing the processes from step SP9 to step SP10, face authentication is realized.

First, in step SP1, face images (images G1 and G2) of a predetermined person (person to be authenticated), captured by the cameras CA1 and CA2 are input to the controller 10 via a communication line. Each of the cameras CA1 and CA2 for capturing face images is a general image capturing apparatus capable of capturing a two-dimensional image. A camera parameter Bi (i=1 . . . N) indicative of the positional posture of each camera CAi or the like is known and pre-stored in the camera parameter storage 27 (FIG. 4). N indicates the number of cameras. Although the case where N=2 is described in the preferred embodiment, N may be three or more (N≧3, three or more cameras may be used). The camera parameter Bi will be described later.

In step SP2, an area in which the face exists is detected from each of the two images (images G1 and G2) input from the cameras CA1 and CA2. As a face area detecting method, for example, a method of detecting a face area from each of the two images by template matching using a prepared standard face image can be employed.

In step SP3, the position of a feature part in the face is detected from the face area image detected in step SP2. Examples of the feature parts in the face are eyes, eyebrows, nose, and mouth. In step SP3, the coordinates of feature points Q1 to Q23 of the parts as shown in FIG. 7 are calculated. A feature part can be detected by template matching using a standard template of the feature part. The coordinates of a feature point calculated are expressed as coordinates on the images G1 and G2 input from the cameras. For example, with respect to the feature point Q20 corresponding to the right end of the mouth in FIG. 8, as shown in FIG. 8, coordinate values in the two images G1 and G2 are calculated. Concretely, by using the upper left end point of the image G1 as the origin O, coordinates (x1, y1) on the image G1 of the feature point Q20 are calculated. In the image G2 as well, similarly, coordinates (x2, y2) on the image G2 of the feature point Q20 are calculated.

A brightness value of each of pixels in an area using, as an apex point, a feature point in an input image is acquired as information of the area (hereinafter, also referred to as “texture information”). The texture information in each area is pasted (mapped) to an individual model in step SP5 or the like which will be described later. In the case of the preferred embodiment, the number of input images is two, so that an average brightness value in corresponding pixels in corresponding areas in the images is used as the texture information of the area.

In step SP4 (three-dimensional reconstruction process), three-dimensional coordinates M^{(j)} (j=1 . . . m) of each feature point Qj are calculated on the basis of two-dimensional coordinates Ui^{(j)} in each of images Gi (i=1, . . . , N) at each of the feature points Qj detected in step SP3 and the camera parameters Bi of the camera which has captured each of images Gi. “m” denotes the number of feature points.

Calculation of the three-dimensional coordinates M^{(j)} will be described concretely below.

The relations among the three-dimensional coordinates M^{(j)} at each feature point Qj, the two-dimensional coordinates Ui^{(j)} at each feature point Qj, and the camera parameter Bi are expressed as Expression (1).
μiUi^{(j)}=BiM^{(j)} (1)

Herein, μi is a parameter indicative of a fluctuation amount of a scale. A camera parameter matrix Bi indicates values peculiar to each camera, which are obtained by capturing an object whose three-dimensional coordinates are previously known, and is expressed by a projection matrix of 3×4.

As a concrete example of calculating three-dimensional coordinates by using Expression (1), the case of calculating three-dimensional coordinates M⁽²⁰⁾ at a feature point Q20 will be considered with reference to FIG. 8. Expression (2) shows the relation between coordinates (x1, y1) at the feature point Q20 on the image G1 and three-dimensional coordinates (x, y, z) when the feature point Q20 is expressed in a three-dimensional space. Similarly, Expression (3) shows the relation between the coordinates (x2, y2) at the feature point Q20 on the image G2 and the three-dimensional coordinates (x, y, z) when the feature point Q20 is expressed in a three-dimensional space.

$$\begin{matrix}μ 1 ( \begin{matrix}x 1 \\ y 1 \\ 1\end{matrix} ) = B 1 ( \begin{matrix}x \\ y \\ z \\ 1\end{matrix} ) & ( 2 ) \\ μ 2 ( \begin{matrix}x 2 \\ y 2 \\ 1\end{matrix} ) = B 2 ( \begin{matrix}x \\ y \\ z \\ 1\end{matrix} ) & ( 3 )\end{matrix}$$

Unknown parameters in Expressions (2) and (3) are total five parameters; two parameters μ1 and μ2 and three component values x, y, and z of three-dimensional coordinates M⁽²⁰⁾. On the other hand, the number of equalities included in Expressions (2) and (3) is six, so that each of the unknown parameters, that is, three-dimensional coordinates (x, y, z) at the feature point Q20 can be calculated. Similarly, three-dimensional coordinates M^{(j)} at all of feature points Qj can be acquired.

In step SP5, model fitting is performed. The “model fitting” is a process of generating an “individual model” in which input information of the face of a person HM to be authenticated is reflected by modifying a “standard model (of a face)” as a model of a prepared general (standard) face by using the information of the person HM to be authenticated. Concretely, a process of changing three-dimensional information of the standard model by using the calculated three-dimensional coordinates M^{(j)} and a process of changing two-dimensional information of the standard model by using the texture information are performed.

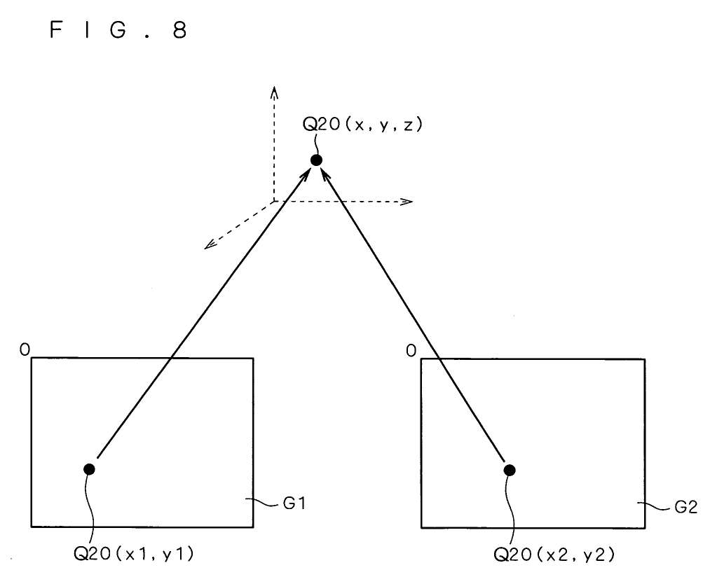

FIG. 9 shows a standard model of a three-dimensional face.

The face standard model shown in FIG. 9 is constructed by apex data and polygon data and is stored as the three-dimensional model database 28 (FIG. 4) in the storage 3 or the like. The apex data is a collection of coordinates of an apex (hereinafter, also referred to as “standard control point”) COj of a feature part in the standard model and corresponds to the three-dimensional coordinates at each feature point Qj calculated in step SP4 in a one-to-one correspondence manner. The polygon data is obtained by dividing the surface of the standard model into small polygons (for example, triangles) and expressing the polygons as numerical value data. FIG. 9 shows the case where the apex of a polygon is constructed also by an intermediate point other than the standard control point COj. The coordinates at an intermediate point can be obtained by a proper interpolating method.

Model fitting for constructing an individual model from a standard model will now be described specifically.

First, the apex (standard control point COj) of each of feature parts of the standard model is moved to the feature point calculated in step SP4. Concretely, a three-dimensional coordinate value at each feature point Qj is substituted as the three-dimensional coordinate value of the corresponding standard control point COj, thereby obtaining a standard control point (hereinafter, also referred to as “individual control point”) Cj after the movement. In such a manner, the standard model can be modified to an individual model expressed by the three-dimensional coordinates M^{(j)}.

From the movement amount of each apex by the modification (movement), the scale, tilt, and position of the individual model in the case of using the standard model as a reference, which are used in step SP6 to be described later, can be obtained. Concretely, a position change of the individual model with respect to the standard model can be obtained by a deviation amount between a predetermined reference position in the standard model and a corresponding reference position in the individual model derived by the modification. According to a deviation amount between a reference vector connecting predetermined two points in the standard model and a reference vector connecting points corresponding to the predetermined two points in the individual model derived by the modification, a change in the tilt and a scale change in the individual model with respect to the standard model can be obtained. For example, by comparing coordinates at an intermediate point QM between the feature point Q1 at the inner corner of the right eye and the feature point Q2 at the inner corner of the left eye with coordinates at a point corresponding to the intermediate point QM in the standard model, the position of the individual model can be obtained. Further, by comparing the intermediate point QM with other feature points, the scale and the tilt of the individual model can be calculated.

The following expression (4) shows a conversion parameter (vector) vt expressing the correspondence relation between the standard model and the individual model. As shown in Expression (4), the conversion parameter (vector) vt is a vector having, as elements, a scale conversion index sz of both of the models, the conversion parameters (tx, ty, tz) indicative of translation displacements in orthogonal three axis directions, and conversion parameters (φ, θ, ψ) indicative of rotation displacements (tilt).
vt=(sz,φ,θ,ψ,tx,ty,tz)^{T} (4)

(where T denotes transposition, which also applies below)

As described above, the process of changing the three-dimensional information of the standard model by using the three-dimensional coordinates M^{(j)} of the person HM to be authenticated is performed.

After that, the process of changing the two-dimensional information of the standard model by using the texture information is also performed. Concretely, the texture information of the parts in the input images G1 and G2 is pasted (mapped) to corresponding areas (polygons) on the three-dimensional individual model. Each area (polygon) to which the texture information is pasted on a three-dimensional model (such as individual model) is also referred to as a “patch”.

The model fitting process (step SP5) is performed as described above.

In step SP6, the individual model is corrected on the basis of the standard model as a reference. In the process, a position correction (alignment correction) related to the three-dimensional information and a texture correction related to the two-dimensional information are made.

The alignment correction (face direction correction) is performed on the basis of the scale, tilt, and position of the individual model obtained in step SP5 using the standard model as a reference. More specifically, by converting coordinates of an individual control point in an individual model by using the conversion parameter vt (refer to Expression 4) indicative of the relation between the standard model as a reference and the individual model, a three-dimensional face model having the same posture as that of the standard model can be created. That is, by the alignment correction, the three-dimensional information of the person HM to be authenticated can be properly normalized.

Next, texture correction will be described. In the texture correction, texture information is normalized.

The normalization of texture information is a process of standardizing texture information by obtaining the corresponding relation between each of individual control points (feature points) in an individual model and each of corresponding points (correspondence standard positions) in a standard model. By the process, texture information of each of patches in an individual model can be changed to a state where the influence of a change in a patch shape (concretely, a change in the facial expression) and/or a change in the posture of the face is suppressed.

The case of generating, as a sub model, a stereoscopic model obtained by pasting texture information of each of the patches in an individual model to an original standard model (used for generating the individual model) separately from the individual model will be described. The texture information of each of the patches pasted to the sub model has a state in which the shape of each of the patches and the posture of the face are normalized.

Specifically, after moving each of individual control points (feature points) of an individual model to each of corresponding points in an original standard model, texture information of the person to be authenticated is standardized. More specifically, the position of each of pixels in each patch in the individual model is normalized on the basis of three-dimensional coordinates of an individual control point Cj in the patch, and the brightness value (texture information) of each of the pixels in the individual model is pasted to a corresponding position in a corresponding patch in an original standard model. The texture information pasted to the sub model is used for the comparing process on the texture information in similarity calculating process (step SP9) which will be described later.

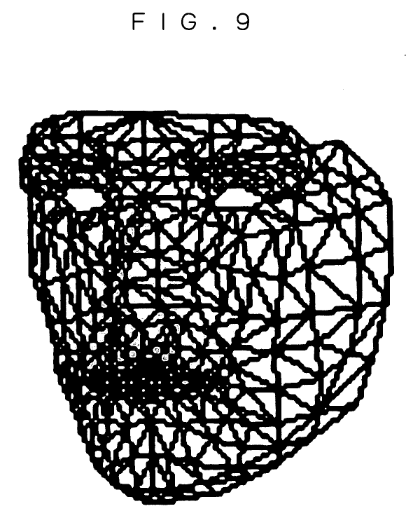

FIG. 10 is a conceptual diagram showing normalization of texture information in a predetermined patch. The normalization of texture information will be described more specifically with reference to FIG. 10.

For example, it is assumed that a patch KK2 in an individual model and a patch HY in an original standard model correspond to each other. A position γK2 in the patch KK2 in the individual model is expressed by a linear sum of independent vectors V21 and V22 connecting points of different two sets in the individual control points Cj (j=J1, J2, and J3) of the patch KK2. A position γHY in the patch HY in the standard model is expressed by a linear sum of corresponding vectors V01 and V02 by using the same coefficients as those in the linear sum of the vectors V21 and V22. The corresponding relation between both of the positions γK1 and γHY is obtained, and the texture information of the position γK2 in the patch KK2 can be pasted to the corresponding position γHY in the patch HY. By executing such texture information pasting process on all of the texture information in the patch KK2 in the individual model, the texture information in the patch in the individual model is converted to texture information in the patch in the sub model, and the texture information is obtained in a normalized state.

The two-dimensional information (texture information) of the face in the sub model has the property such that it is not easily influenced by fluctuations in the posture of the face, a change in the facial expression, and the like. For example, in the case where the postures and facial expressions in two individual models of the same person are different from each other, when the above-described texture information normalization is not performed, the corresponding relation between patches in the individual models (for example, in FIG. 10, the patches KK1 and KK2 originally correspond to each other) and the like cannot be obtained accurately and the possibility that the models are erroneously determined as different persons is high. In contrast, when the texture information is normalized, the postures of the faces become the same, and the relation of corresponding positions of each patch can be obtained with higher accuracy, so that the influence of a change in posture is suppressed. By the normalization of the texture information, the shapes of each patch constructing the surface of the face become the same as those of each corresponding patch in the standard model (refer to FIG. 10). Thus, the shapes of each patch become the same (normalized) and the influence of a change in the facial expression is suppressed. For example, an individual model of a smiling person is standardized by being converted to a sub model of a straight face by using a standard model of a straight face (with no facial expression). By the operation, the influence of a change in texture information caused by a smile (for example, a change in the position of a mole) is suppressed. As described above, the normalized texture information is valid for personal authentication.

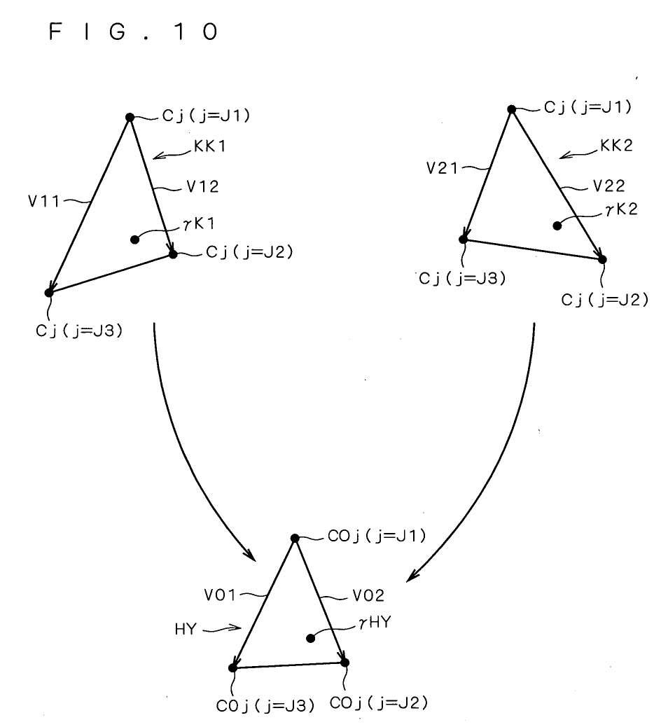

The texture information pasted to a sub model can be further changed to a projection image as shown in FIG. 11 so as to be easily compared.

FIG. 11 shows an image obtained by projecting texture information subjected to the texture correction, that is, texture information pasted to a sub model into a cylindrical surface disposed around the sub model. The texture information of the projection image is normalized and has the property that it does not depend on the shape and posture, so that the texture information is very useful as information used for personal identification.

As described above, in step SP6, the three-dimensional information and the two-dimensional information of the person HM to be authenticated is generated in a normalized state.

In step SP7 (FIG. 6), as information indicative of features of the person HM to be authenticated, three-dimensional shape information (three-dimensional information) and texture information (two-dimensional information) is extracted.

As the three-dimensional information, a three-dimensional coordinate vector of m pieces of the individual control points Cj in the individual model is extracted. Concretely, as shown in Expression (5), a vector h^{S} (hereinafter, also referred to as “three-dimensional coordinate information) having, as elements, three-dimensional coordinates (Xj, Yj, Zj) of the m pieces of individual control points Cj (j=1, . . . , m) is extracted as the three-dimensional information (three-dimensional shape information).
h^{S}=(X1, . . . ,Xm,Y1, . . . ,Ym,Z1, . . . ,Zm)^{T} (5)

As the two-dimensional information, texture (brightness) information of a patch or a group (local area) of patches (hereinafter, also referred to as “local two-dimensional information”) near a feature part, that is, an individual control point in the face, which is important information for personal authentication is extracted. In this case, as texture information (local two-dimensional information), information mapped to the sub model is used.

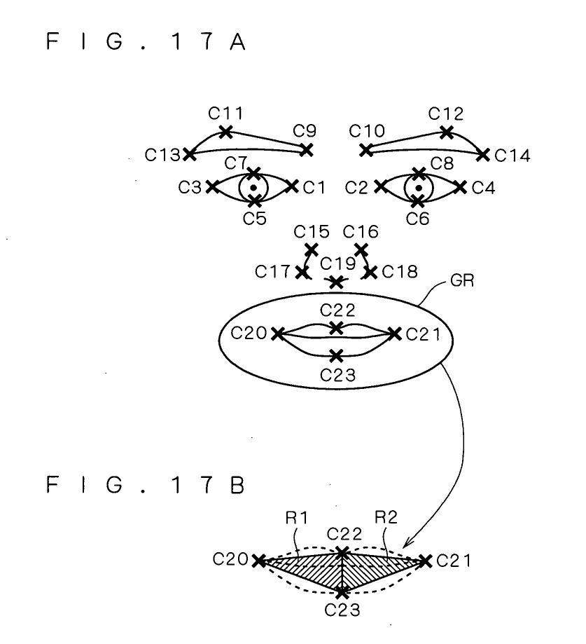

The local two-dimensional information is comprised of, for example, brightness information of pixels of local areas such as an area constructed by a group GR in FIG. 17A indicative of individual control points of a feature part after normalization (a patch R1 having, as apexes, individual control points C20, C22, and C23 and a patch R2 having, as apexes, individual control points C21, C22, and C23), an area constructed only by a single patch, or the like. The local two-dimensional information h^{(k)} (k=1, . . . , and L; L is the number of local areas) is expressed in a vector form as shown by Expression (6) when the number of pixels in the local area is “n” and brightness values of the pixels are BR1, . . . , and BRn. Information obtained by collecting the local two-dimensional information h^{(k)} in L local areas is also expressed as overall two-dimensional information.
h^{(k)}=(BR1, . . . ,BRn)^{T} (6)

(k=1 . . . L)

As described above, in step SP7, the three-dimensional shape information (three-dimensional information) and the texture information (two-dimensional information) is extracted as information indicative of a feature of the person HM to be authenticated.

In step SP8, an information compressing process, which will be described below, for converting the information extracted in step SP7 to information adapted to authentication is performed.

The information compressing process is performed using each of the feature transformation dictionaries EA3 obtained by the dictionary generating operation PHA1, respectively, on the three-dimensional shape information h^{S} and each local two-dimensional information h^{(k)}. In the following, the information compressing process for the three-dimensional shape information h^{S} and the information compressing process for the local two-dimensional information h^{(k)} will be described in this order.

The information compressing process performed on the three-dimensional shape information h^{S} is a process of converting an information space expressed by the three-dimensional shape information h^{S} to a subspace which is not easily influenced by a change in the shape of the face (a change in facial expression) and which allows features of persons to be recognized separated widely from each other.

It is assumed that a transformation matrix for three-dimensional shape information (hereinafter, also referred to as “three-dimensional information transformation matrix”) At is used as such an information compressing process. The three-dimensional information transformation matrix At is a transformation matrix for projecting the three-dimensional shape information h^{S} to a subspace which increases variations among persons (between-class variance β) more than variations in a person (within-class variance α) and reduces vector size (the number of dimensions of the vector) SZ1 (=3×m) of the three-dimensional shape information h^{S} to a value SZ0. By performing transformation as shown by the expression (7) using the three-dimensional information transformation matrix At, the information space expressed by the three-dimensional shape information h^{S} can be transformed (projected) to a subspace (feature space) expressed by a three-dimensional feature amount d^{S}.
d^{S}=At^{T}h^{S} (7)

The function of the three-dimensional information transformation matrix At will be described in detail.

The three-dimensional information transformation matrix At has the function of selecting information of high personal discriminability from the three-dimensional shape information h^{S}, that is, the information compressing function.

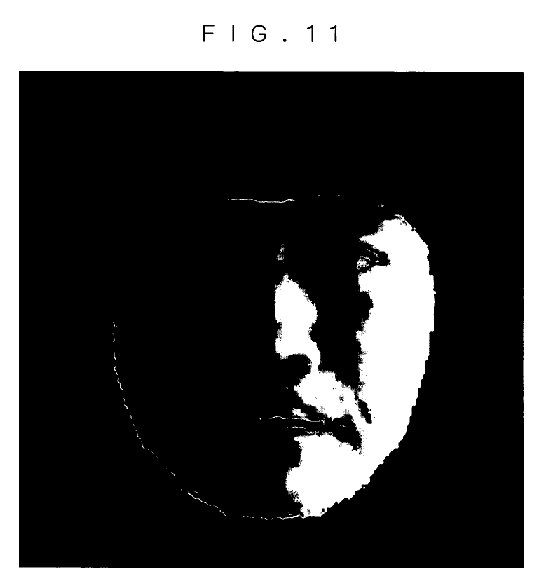

Concretely, the three-dimensional information transformation matrix At has the function of selecting a principal component vector which is not easily influenced by a change in facial expression and largely separates persons (a principal component vector having a relatively high ratio F (which will be described later)) such as a principal component vector IX1 (refer to FIG. 12) to be described later from a plurality of principal component vectors of the three-dimensional shape information h^{S} and compressing the three-dimensional shape information h^{S} to the three-dimensional feature amount d^{S}.

Such a principal component vector is selected using the relation between a within-class variance and a between-class variance on a projection component to each of the principal component vectors of the three-dimensional shape information h^{S}.

More specifically, first, SZ0 pieces of principal component vectors having the high ratio F (=β/α) between the within-class variance α and the between-class variance β are selected from a plurality of principal component vectors of the three-dimensional shape information h^{S}. The vector h^{S} expressing the three-dimensional shape information is transformed to the vector d^{S} in a vector space expressed by the selected SZ0 pieces of principal component vectors. The vector d^{S} obtained by the transformation with the three-dimensional information transformation matrix At can remarkably express the difference among persons while preventing the influence of a variation (change) in the shape of the face caused by facial expression change or the like within a person. A method of obtaining the three-dimensional information transformation matrix At will be described later.

The information compressing process can be also said as a process of compressing the three-dimensional shape information h^{S} to the three-dimensional feature amount (three-dimensional shape feature information) d^{S} by transforming the three-dimensional shape information h^{S} by using a predetermined mapping relation f(h^{S}→d^{S}).

The method of obtaining the three-dimensional information transformation matrix At will be described with reference to FIG. 12. The three-dimensional information transformation matrix At is information preliminarily obtained by the dictionary generating operation PHA1 and stored in the feature transformation dictionary EA3. FIG. 12 is a flowchart showing the dictionary generating operation PHA1.

In the dictionary generating operation PHA1, processes similar to steps SP1 to SP7 on sample face images showing various facial expressions of a plurality of people are executed, thereby extracting the three-dimensional information and the two-dimensional information of each of all of the sample face images (step SP21).

For example, twenty face images showing various facial expressions such as joy, anger, surprise, sadness, and fear are collected per person. The operation is repeated for 100 persons, thereby collecting 2,000 kinds of face images as sample images. By performing the processes in steps SP1 to SP7 on each of the sample images, three-dimensional information and two-dimensional information can be extracted from each of the 2,000 kinds of sample images.

In step SP22, the transformation matrix for three-dimensional shape information (three-dimensional information transformation matrix) At and a transformation matrix for two-dimensional information (hereinafter, also referred to as “two-dimensional information transformation matrix”) Aw^{(k)} are generated on the basis of the plurality of pieces of three-dimensional information and the plurality of pieces of two-dimensional information, respectively, by a statistical method. Generation of the three-dimensional information transformation matrix At will be described here, and generation of the two-dimensional information transformation matrix Aw^{(K)} will be described later.

The three-dimensional information transformation matrix At is generated by using a method MA of performing feature selection in consideration of a within-class variance and a between-class variance after executing principal component analysis.

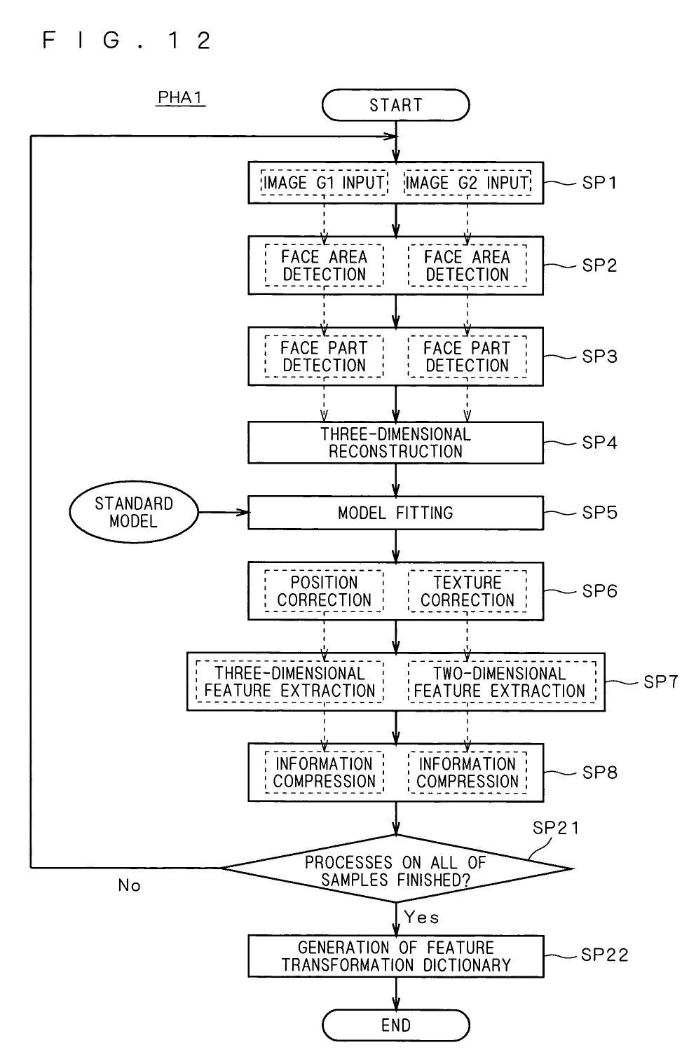

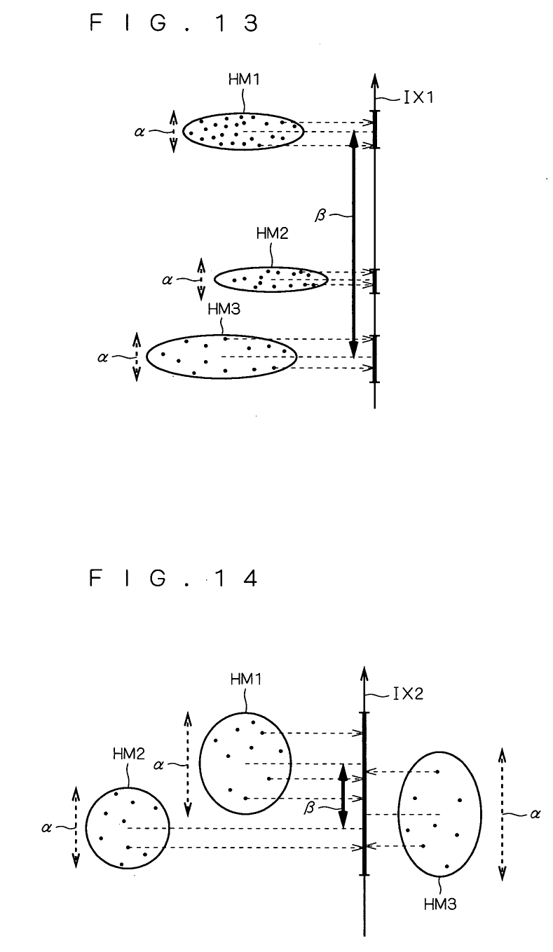

The more details will be described with reference to FIGS. 13 to 16. FIGS. 13 to 16 are diagrams each schematically showing a distribution state of the three-dimensional shape information h^{S} of each sample image for explaining a state of projection to a predetermined principal component vector (IX1 to IX4) of principal component vectors IXγ (γ=1, . . . , 3×m) constructing the three-dimensional shape information h^{S} of each person (HM1, HM2, and HM3). In the diagrams, a facial expression of a person is expressed by one point, and points of the same person are expressed in the same ellipse. As described above, in reality, it is preferable to capture sample images of a number (for example, 100 or more) of persons. For simplicity of the drawings, the case of capturing sample images of various facial expressions of three persons will be described here.

As shown in FIG. 13, components of projection to the principal component vector IX1 of the three-dimensional shape information (vector) h^{S} corresponding to each facial expression of each person will be assumed. With respect to a component of projection to the principal component vector IX1, a within-class variance α as variations in a person and a between-class variance β as variations among persons are obtained. In FIG. 13 and the like, a single-head arrow extending from each point to the principal component vector expresses “projection” to the principal component vector IX1. A double-headed broken line arrow and a double-headed solid line arrow schematically show the within-class variance α and the between-class variance β, respectively, of a projection component.

Similarly, the within-class variance α and the between-class variance β of each of projection components of the other principal component vectors IX2, IX3, IX4, IX5, . . . are obtained (FIGS. 14 to 16).

SZ0 pieces of the principal component vectors are selected in descending order of the ratio F (=β/α) between the within-class variance α and the between-class variance β from a plurality of principal component vectors of the three-dimensional shape information h^{S}.

For simplicity, it is assumed that each principal component vector IXγ is a unit vector in which only the γth (γ=1, . . . , 3×m) component (hereinafter, also referred to as “corresponding component”) is 1 and the other components are zero.

In this case, the transformation matrix At is constructed on assumption that corresponding components (the q-th components) in the selected SZ0 pieces of principal component vectors IXq are extracted from the vector h^{S} and corresponding components in not-selected (3×m−SZ0) pieces of principal component vectors are not extracted from the vector h^{S}.

When the principal component vectors IX1 to IX4 shown in FIGS. 13 to 16 are compared with each other, the principal component vector having the highest ratio (F=β/α) between the within-class variance α and the between-class variance β is the principal component vector IX1. Therefore, in generation of the transformation matrix At using the method MA, first, the principal component vector IX1 is selected from the principal component vectors IX1 to IX4. The transformation matrix At is constructed so as to extract the corresponding component (first component) in the principal component vector IX1 from the vector h^{S}.

The principal component vector having the second highest ratio F between the within-class variance α and the between-class variance β next to the principal component vector IX1 is a principal component vector IX3. In this case, the transformation matrix At is constructed so as to extract also the corresponding component in the principal component vector IX3 from the vector h^{S}.

Similarly, SZ0 pieces of principal component vectors having relatively high ratio F are selected, and the transformation matrix At for extracting corresponding components in the selected principal component vectors is generated.

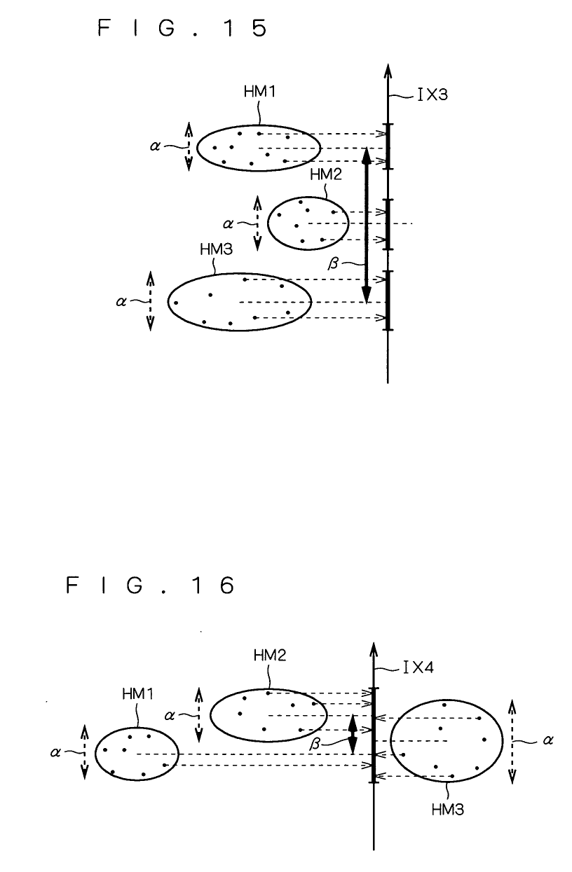

On the other hand, as shown in FIGS. 14 and 16, the ratio F of each of the principal component vectors IX2 and IX4 is relatively low. In this case, the principal component vectors IX2 and IX4 are not selected. Therefore, the transformation matrix At is constructed so as not to extract the corresponding components in the principal component vectors IX2 and IX4 from the vector h^{S}.

As described above, the transformation matrix At is constructed so as to extract only the corresponding components in the SZ0 pieces of principal component vectors selected from all of the principal component vectors and so as not to extract the corresponding components in the not-selected principal component vectors. The transformation matrix At is a matrix whose size in the vertical direction is SZ0 and whose size in the lateral direction is (3×m). That is, the information amount of the three-dimensional shape is compressed from (3×m) to SZ0.

Although the case of selecting the predetermined number (SZ0) of principal component vectors from a plurality of principal component vectors is described above, the present invention is not limited to the above case. It is also possible to determine a threshold FTh for the ratio F, select principal component vectors having the ratio F higher than the threshold FTh from a plurality of principal component vectors, and construct the transformation matrix At by using the selected principal component vectors.

By the transformation matrix At generated as described above, an information space expressed by the three-dimensional shape information h^{S} can be transformed to a subspace showing information which is insusceptible to a shape change (expression change) of the face in the three-dimensional shape information h^{S} and showing information (feature information) which increases differences among persons.

It is now assumed that the vector space of the three-dimensional shape information h^{S} is virtually separated into a first subspace in which the influence of a change in the facial expression is relatively small and which is suitable for discrimination among persons and a second subspace in which the influence of a change in the facial expression is relatively large and which is not suitable for discrimination among persons. In this case, the mapping relation f (h^{S}→d^{S}) can be expressed as a relation for transforming an arbitrary vector in a vector space expressing a three-dimensional shape of the face of a person to a vector in the first subspace.

As described above, a plurality of images of various facial expressions of a plurality of persons are collected as sample images and, on the basis of the plurality of sample images, the mapping relation f (h^{S}→d^{S}) (in this case, the three-dimensional information transformation matrix At) can be obtained.

The information compressing process on the local two-dimensional information h^{(k)} will now be described.

Since the local two-dimensional information h^{(k)} is a collection of brightness values of pixels in the local area, the information amount (the number of dimensions) is greater than the three-dimensional shape information h^{S}. Consequently, in the information compressing process on the local two-dimensional information h^{(k)} of the preferred embodiment, the compressing process is performed in two stages: compression using KL expansion and compression using the two-dimensional information transformation matrix Aw^{(k)}.

The local two-dimensional information h^{(k)} can be expressed in a basis decomposition form as shown by Expression (8) using average information (vector) hₐᵥₑ^{(k)} of the local area preliminarily obtained from a plurality of sample face images and a matrix P^{(k)} (which will be described below) expressed by a set of eigenvectors of the local area preliminarily calculated by performing KL expansion on the plurality of sample face images. As a result, a local two-dimensional face information (vector) c^{(k)} is obtained as compression information of the local two-dimensional information h^{(k)}.
h^{(k)}=hₐᵥₑ^{(k)}+P^{(k)}c^{(k)} (8)

As described above, the matrix P^{(k)} in Expression (8) is calculated from a plurality of sample face images. Concretely, the matrix P^{(k)} is calculated as a set of some eigenvectors (basis vectors) having large eigenvalues among a plurality of eigenvectors obtained by performing the KL expansion on the plurality of sample face images. The basis vectors are stored in the feature transformation dictionary storage 29. When a face image is expressed by using, as basis vectors, eigenvectors showing greater characteristics of the face image, the features of the face image can be expressed efficiently.

For example, the case where local two-dimensional information h^{(GR)} of a local area constructed by a group GR shown in FIG. 17 is expressed in a basis decomposition form will be considered. When it is assumed that a set P of eigenvectors in the local area is expressed as P=(P1, P2, P3) by three eigenvectors P1, P2, and P3, the local two-dimensional information h^{(GR)} is expressed as Expression (9) using average information hₐᵥₑ^{(GR)} of the local area and three eigenvectors P1, P2, and P3. The average information hₐᵥₑ^{(GR)} is a vector obtained by averaging a plurality of pieces of local two-dimensional information (vectors) of various sample face images on each corresponding factor. As the plurality of sample face images, it is sufficient to use a plurality of standard face images having proper variations.

$${h}^{( GR )} = {h}_{ave}^{( GR )} + ( P 1 P 2 P 3 ) ( \begin{matrix}c 1 \\ c 2 \\ c 3\end{matrix} ) \qquad ( 9 )$$

Expression (9) shows that the original local two-dimensional information can be reproduced by face information c^{(GR)}=(c1, c2, c3)^{T}. In other words, the face information c^{(GR)} is information obtained by compressing the local two-dimensional information h^{(GR)} of the local area constructed by the group GR.

Subsequently, a process of converting a feature space expressed by the local two-dimensional face information c^{(GR)} to a subspace which allows features of persons to be recognized separated widely from each other is performed with the two-dimensional information transformation matrix Aw^{(k)}. More specifically, a two-dimensional information transformation matrix Aw^{(GR)} is used which reduces the local two-dimensional face information c^{(GR)} of vector size SZ2 to the local two-dimensional feature amount d^{(GR)} of vector size SZ3 as shown by Expression (10). As a result, the feature space expressed by the local two-dimensional face information c^{(GR)} can be transformed to a subspace expressed by the local two-dimensional feature amount d^{(GR)}. Thus, the differences (separations) among persons are made conspicuous.
d^{(GR)}=(Aw^{(GR)})^{T}c^{(GR)} (10)

The two-dimensional information transformation matrix Aw^{(k)} is, like the three-dimensional information transformation matrix At, preliminarily obtained by the dictionary generating operation PHA1 and is stored in the feature transformation dictionary EA3.

Concretely, in the dictionary generating operation PHA1, the local two-dimensional information is extracted every local area in all of the sample face images (step SP21). In step SP22, on the basis of the local two-dimensional face information C^{(k)} obtained by executing the KL expansion on the local two-dimensional information h^{(k)}, the transformation matrix Aw^{(k)} for two-dimensional information (hereinafter, also referred to as “two-dimensional information transformation matrix”) is generated. The two-dimensional information transformation matrix Aw^{(k)} is generated, by using the above-described method MA, by selecting SZ3 pieces of components having high ratio (F=β/α) between the within-class variance α and the between-class variance β from components of a feature space expressed by the local two-dimensional face information C^{(k)}.

By executing processes similar to the information compressing process performed on the local two-dimensional information h^{(GR)} on all of the other local areas, local two-dimensional face feature amounts d^{(k)} of the local areas can be obtained.

A face feature amount “d” obtained by combining the three-dimensional face feature amount d^{S} and the local two-dimensional face feature amount d^{(k)} acquired in step SP8 can be expressed in a vector form as shown by Expression (11).

$$d = ( \begin{matrix}{d}^{S} \\ {d}^{( 1 )} \\ ⋮ \\ {d}^{( L )}\end{matrix} ) \qquad ( 11 )$$

In the above-described processes in steps SP1 to SP8, the face feature amount “d” of a person HM to be authenticated is obtained from input face images of the person HM to be authenticated.

In steps SP9 and SP10, face authentication of a predetermined person is performed using the face feature amount “d”.

Concretely, overall similarity Re as similarity between the person HM to be authenticated (an object to be authenticated) and a person to be compared (an object to be compared) is calculated (step SP9). After that, a comparing (determining) operation between the person HM to be authenticated and the person to be compared on the basis of the overall similarity Re is performed (step SP10). The overall similarity Re is calculated using weight factors specifying weights on three-dimensional similarity Re^{S} and local two-dimensional similarity Re^{(k)} (hereinafter, also simply referred to as “weight factors”) in addition to the three-dimensional similarity Re^{S} calculated from the three-dimensional face feature amount d^{S} and local two-dimensional similarity Re^{(k)} calculated from the local two-dimensional face feature amount d^{(k)}. As the weight factors WT and WS in the preferred embodiment, predetermined values are used.

In step SP9, evaluation is conducted on similarity between the face feature amount (feature amount to be compared) of a person to be compared which is preliminarily registered in the person database 30 and the face feature amount of the person HM to be authenticated, which is calculated in steps SP1 to SP8. Concretely, similarity calculation is performed between the registered face feature amounts (feature amounts to be compared) (d^{SM} and d^{(k)M}) and the face feature amounts (d^{SI} and d^{(k)I}) of the person HM to be authenticated, thereby calculating three-dimensional similarity Re^{S} and local two-dimensional similarity Re^{(k)}.

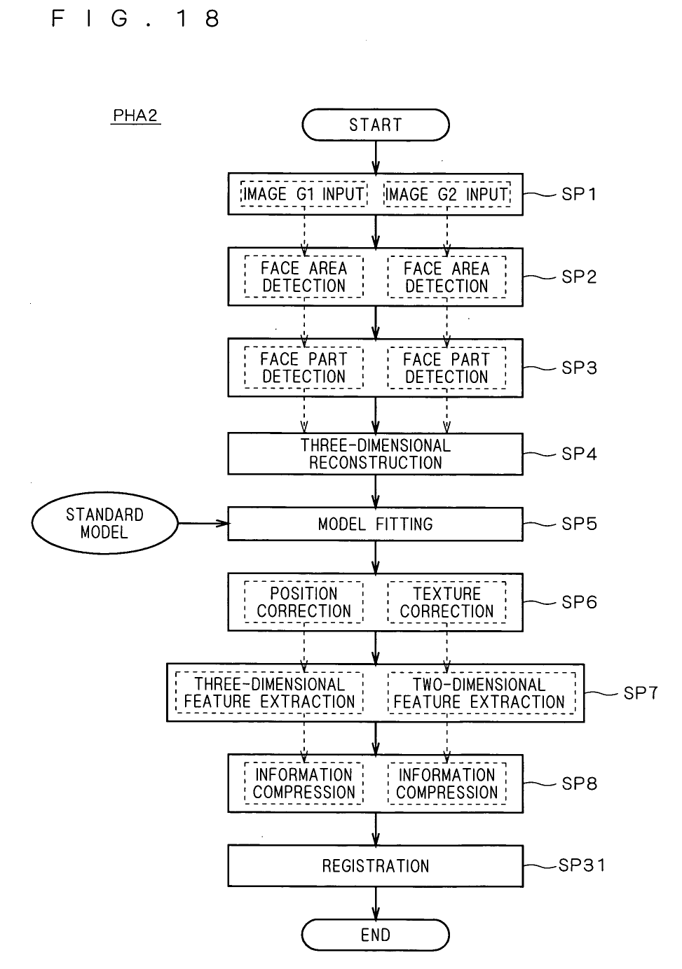

In the preferred embodiment, the face feature amount of a person to be compared (an object to be compared) in the face authenticating operation is obtained in the registering operation PHA2 in FIG. 18 that is executed prior to the authenticating operation PHA3 (FIG. 6).

Concretely, in the registering operation PHA2, as shown in FIG. 18, processes similar to steps SP1 to SP8 are performed on a single person to be compared or each of a plurality of persons to be compared, thereby obtaining the face feature amount “d” of each of the person(s) to be compared is obtained. In step SP31, the face feature amount “d” is pre-stored (registered) in the person database 30.

The operations in steps SP1 to SP8 in the registering operation PHA2 will be briefly described. In steps SP1 to SP5, an individual model in which input information on the face of a person to be compared is reflected is generated. In step SP6, a position correction on three-dimensional information of the individual model using a standard model as a reference and a texture correction on the two-dimensional information using a sub model are executed. In step SP7, as information indicative of the feature of the person to be compared, three-dimensional shape information (three-dimensional information) and texture information (two-dimensional information) is extracted. Specifically, the three-dimensional shape information is extracted from the individual model, and the texture information is extracted from the sub model. In step SP8, information compressing process of converting the information extracted in step SP7 to information adapted to authentication is performed, and the face feature amount “d” of the person to be compared is obtained.

The three-dimensional similarity Re^{S} between the person HM to be authenticated and the person to be compared is obtained by calculating Euclidean distance Re^{S} between corresponding vectors as shown by Expression (12).
Re^{S}=(d^{SI}−d^{SM})^{T}(d^{SI}−d^{SM}) (12)

The local two-dimensional similarity Re^{(k)} is obtained by calculating Euclidean distance Re^{(k)} of each of vector components of the feature amounts in the corresponding local areas as shown by Expression (13).
Re^{(k)}=(d^{(k)I}−d^{(k)M})^{T}(d^{(k)I}−d^{(k)M}) (13)

As shown in Expression (14), the three-dimensional similarity Re^{S} and the local two-dimensional similarity Re^{(k)} are combined by using the weight factors WT and WS. In such a manner, the overall similarity Re as similarity between the person HM to be authenticated (object to be authenticated) and the person to be compared (object to be compared) can be obtained.

$$Re = WT \cdot {Re}^{S} + WS \cdot {\sum }_{k} {Re}^{( k )} \qquad ( 14 )$$

In step SP10, authentication determination is performed on the basis of the overall similarity Re. The authentication determination varies between the case of face verification and the case of face identification as follows.

In the face verification, it is sufficient to determine whether an input face (the face of a person HM to be authenticated) is that of a specific registered person or not. Consequently, by comparing the similarity Re between the face feature amount of the specific registered person, that is, a person to be compared (a feature amount to be compared) and the face feature amount of the person to be authenticated with a predetermined threshold, whether the person HM to be authenticated is the same as the person to be compared or not is determined. Specifically, when the similarity Re is smaller than a predetermined threshold TH1, it is determined that the person HM to be authenticated is the same as the person to be compared.

On the other hand, the face identification is to determine the person of an input face (the face of the person HM to be authenticated). In the face identification, similarities between each of face feature amounts of persons registered and the feature amount of the face of a person HM to be authenticated are calculated, and a degree of identity between the person HM to be authenticated and each of the persons to be compared is determined. A person to be compared having the highest degree of identity among the plurality of persons to be compared is determined as the same person as the person HM to be authenticated. Specifically, a person to be compared who corresponds to the minimum similarity Reₘᵢₙ among the similarities between the person to be authenticated and each of the plurality of persons to be compared is determined as the same person as the person HM to be authenticated.

As described above, in the controller 10, the three-dimensional shape information h^{S} of the face of a person to be authenticated is converted and compressed to the three-dimensional shape feature information d^{S} which is not susceptible to a fluctuation caused by a change in the facial expression of the person to be authenticated and has high discriminability of a person by using the predetermined mapping relation f(h^{S}→d^{S}). By using the three-dimensional shape feature information d^{S}, the authenticating operation is performed. Thus, high-accuracy authenticating operation which is not easily influenced by a change in the facial expression can be performed.

Modifications

Although the preferred embodiment of the present invention has been described above, the present invention is not limited to the above description.

For example, three-dimensional coordinates (three-dimensional coordinate information) of each of individual control points in an individual model of a face are used as three-dimensional shape information in the foregoing embodiment. The present invention is not limited to the three-dimensional coordinates. Concretely, length of a straight line connecting arbitrary two points in “m” pieces of individual control points (representative points) Cj (j=1, . . . , m) in an individual model, in other words, distance between two arbitrary points (also simply referred to as “distance information”) may be used as the three-dimensional shape information h^{S}.

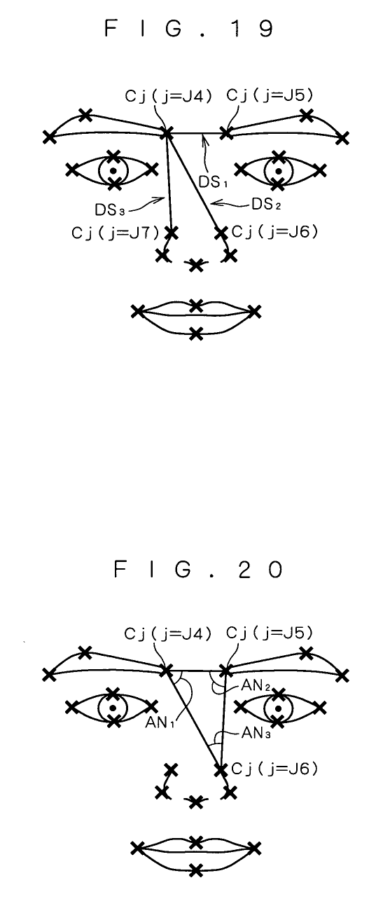

The details will be described with reference to FIG. 19. FIG. 19 is a diagram showing straight lines connecting individual control points. For example, as shown in FIG. 19, lengths DS₁, DS₂, DS₃ and the like of straight lines each connecting an individual control point Cj (j=J4) and another individual control point Cj (j≠J4) in an individual model can be used as elements (components) of the three-dimensional shape information h^{S}. In this case, the three-dimensional shape information h^{S} is expressed as expression (15), and the number of dimensions is m×(m−1)/2. The length (distance) between two arbitrary individual control points Cj can be calculated from the three-dimensional coordinates of the two individual control points.

$${h}^{S} = ( {DS}_{1} , {DS}_{2} , … , {DS}_{\frac{m ( m - 1 )}{2}} \qquad ( 15 )$$

In the information compressing process (step SP8), the three-dimensional feature amount d^{S} is generated by the transformation matrix At that selects, as distance information of high discriminability, at least one element (distance information having high ratio F) from the elements (distance information) constituting the three-dimensional shape information (vector) h^{S}, the at least one element (distance information having high ratio F) being not easily influenced by a change in facial expression and allowing features of persons to be recognized separated widely from each other.

In such a manner, the “distance information” can be also used as the three-dimensional shape information h^{S}.

Alternatively, three angles of a triangle formed by arbitrary three points in the m pieces of individual control points (representative points) Cj (j=1, . . . , m) in an individual model (also simply referred to as “angle information”) may be used as the three-dimensional shape information h^{S}.

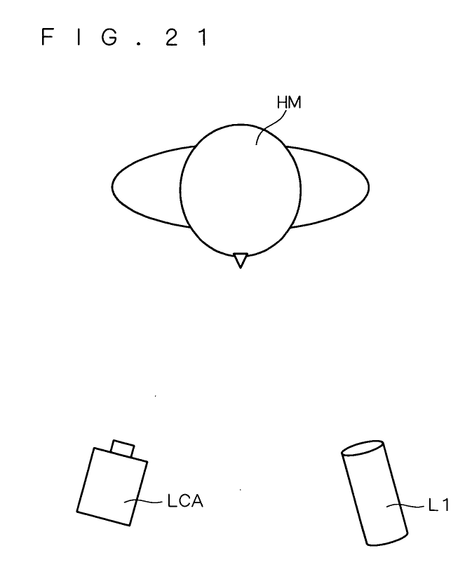

The details will be described with reference to FIG. 20. FIG. 20 is a diagram showing a triangle formed by three individual control points. For example, as shown in FIG. 20, three angles AN₁, AN₂, and AN₃ of a triangle formed by three individual control points Cj (j=J4), Cj (j=J5), and Cj (j=J6) in the individual model can be used as elements of the three-dimensional shape information h^{S}. In this case, the three-dimensional shape information h^{S} is expressed as shown by expression (16), and the number of dimensions is m×(m−1)×(m−2)/2. The three angles of a triangle formed by the arbitrary three individual control points Cj can be calculated from the three-dimensional coordinates of the three individual control points forming the triangle.

$${h}^{S} = ( {AN}_{1} , {AN}_{2} , {AN}_{3} , … , {AN}_{\frac{m ( m - 1 ) \cdot ( m - 2 )}{2}} ) \qquad ( 16 )$$

Alternatively, information obtained by combining any of the three-dimensional coordinate information, distance information, and angle information described above as the elements of the three-dimensional shape information may be used as the three-dimensional shape information h^{S}.

Although the brightness value of each of pixels in a patch is used as two-dimensional information in the foregoing embodiment, color tone of each patch may be used as the two-dimensional information.

Although the similarity calculation is executed using the face feature amount “d” obtained by a single image capturing operation in the foregoing embodiment, the present invention is not limited to the calculation. Concretely, by performing the image capturing operation twice on the person HM to be authenticated and calculating similarity between face feature amounts obtained by the image capturing operations of twice, whether the values of the face feature amounts obtained are proper or not can be determined. Therefore, in the case where the values of the face feature amounts obtained are improper, image capturing can be performed again.

Although the method MA is used as a method of determining the transformation matrix At in step SP6 in the foregoing embodiment, the present invention is not limited to the method. For example, the MDA (Multiple Discriminant Analysis) method for obtaining a projective space in which the ratio between a between-class variance and a within-class variance increases from a predetermined feature space, or the Eigenspace method (EM) for obtaining a projective space in which the difference between a between-class variance and a within-class variance increases from a predetermined feature space may be used.

Although three-dimensional shape information of a face is obtained by using a plurality of images which are input from a plurality of cameras in the preferred embodiment, the present invention is not limited to the method. Concretely, three-dimensional shape information of the face of the person HM to be authenticated may be obtained by using a three-dimensional shape measuring device constructed by a laser beam emitter L1 and a camera LCA as shown in FIG. 21 and measuring reflection light of a laser beam emitted from the laser beam emitter L1 by the camera LCA. However, by a method of obtaining three-dimensional shape information with an input device including two cameras as in the foregoing embodiment, as compared with an input device using a laser beam, three-dimensional shape information can be obtained with a relatively simpler configuration.

As the mapping relation f (h^{S}→d^{S}) for compressing information, a relation expressed by linear transformation (refer to expression (7)) has been described in the preferred embodiment. The present invention, however, is not limited to the relation expressed by linear transformation. A relation expressed by nonlinear transformation may be used.

Although whether the person to be authenticated and a registered person are the same or not is determined by using not only the three-dimensional shape information but also texture information as shown by the expression (14) in the foregoing embodiment, the present invention is not limited to this case. Whether the person to be authenticated and the registered person are the same or not may be determined using only three-dimensional shape information. However, to improve authentication accuracy, it is preferable to use the texture information as well.

While the invention has been shown and described in detail, the foregoing description is in all aspects illustrative and not restrictive. It is therefore understood that numerous modifications and variations can be devised without departing from the scope of the invention.

What is claimed is:

1. An authentication apparatus comprising:
a first acquiring part for acquiring three-dimensional shape information of a face of a target person to be authenticated;
a compressing part for compressing said three-dimensional shape information by using a predetermined mapping relation, thereby generating three-dimensional shape feature information; and
an authenticating part for performing an operation of authenticating said target person by using said three-dimensional shape feature information, wherein
when a vector space expressing said three-dimensional shape information is virtually separated into a first subspace in which the influence of a change in facial expression is relatively small and which is suitable for discrimination among persons and a second subspace in which the influence of a change in facial expression is relatively large and which is not suitable for discrimination among persons, said predetermined mapping relation is decided so as to transform an arbitrary vector in said vector space into a vector in said first subspace.

2. The authentication apparatus according to claim 1, wherein
the number of dimensions of a vector expressing said three-dimensional shape feature information is smaller than that of a vector expressing said three-dimensional shape information.

3. The authentication apparatus according to claim 1, wherein
said vector space is virtually separated into said first subspace and said second subspace by using the relation between a within-class variance and a between-class variance.

4. The authentication apparatus according to claim 1, wherein
said predetermined mapping relation is acquired on the basis of a plurality of images captured while changing facial expressions of each of a plurality of persons.

5. The authentication apparatus according to claim 1, further comprising:
a second acquiring part for acquiring two-dimensional information of the face of said target person, wherein
said authenticating part performs an operation of authenticating said target person by using said two-dimensional information as well.

6. The authentication apparatus according to claim 5, further comprising:
a generating part for generating an individual model of the face of said target person on the basis of said three-dimensional shape information and said two-dimensional information; and
a transforming part for transforming texture information of said individual model to a standardized state, wherein
said transforming part transforms said texture information to a standardized state by using corresponding relations between representative points which are set for said individual model and corresponding standard positions in a standard three-dimensional model, and
said authenticating part performs operation of authenticating said target person by also using the standardized texture information.

7. The authentication apparatus according to claim 6, wherein
said transforming part generates a sub model by mapping said texture information to said standard three-dimensional model using said corresponding relations and transforms said texture information to a standardized state.

8. The authentication apparatus according to claim 7, wherein
said transforming part transforms said texture information to a standardized state by projecting texture information of said sub model to a cylindrical surface disposed around said sub model.

9. The authentication apparatus according to claim 1, wherein
said three-dimensional shape information includes three-dimensional coordinate information of a plurality of representative points which are set for an individual model of the face of said target person.

10. The authentication apparatus according to claim 1, wherein
said three-dimensional shape information includes information of a distance between two points in a plurality of representative points which are set for an individual model of the face of said target person.

11. The authentication apparatus according to claim 1, wherein
said three-dimensional shape information includes angle information of a triangle formed by three points in a plurality of representative points which are set for an individual model of the face of said target person.

12. The authentication apparatus according to claim 9, wherein
said plurality of representative points include a point of at least one of parts of an eye, an eyebrow, a nose, and a mouth.

13. An authentication method comprising the steps of:
a) acquiring three-dimensional shape information of a face of a target person to be authenticated;
b) when a vector space expressing said three-dimensional shape information is virtually separated into a first subspace in which the influence of a change in facial expression is relatively small and which is suitable for discrimination among persons and a second subspace in which the influence of a change in facial expression is relatively large and which is not suitable for discrimination among persons, compressing said three-dimensional shape information to three-dimensional shape feature information by using a predetermined mapping relation of transforming an arbitrary vector in said vector space to a vector in said first subspace; and
c) performing an operation of authenticating said target person by using said three-dimensional shape feature information.

14. The authentication method according to claim 13, wherein
the number of dimensions of a vector expressing said three-dimensional shape feature information is smaller than that of a vector expressing said three-dimensional shape information.

15. The authentication method according to claim 13, wherein
said vector space is virtually separated into said first subspace and said second subspace by using the relation between a within-class variance and a between-class variance.

16. The authentication method according to claim 13, wherein
said predetermined mapping relation is acquired on the basis of a plurality of images captured while changing facial expressions of each of a plurality of persons.

17. The authentication method according to claim 13, further comprising the steps of:
d) acquiring two-dimensional information of the face of said target person;
e) generating an individual model of the face of said target person on the basis of said three-dimensional shape information and said two-dimensional information; and
f) transforming texture information of said individual model to a standardized state, wherein
said step f) includes a sub step of transforming said texture information to a standardized state by using corresponding relations between representative points which are set for said individual model and corresponding standard positions in a standard three-dimensional model, and
said step c) includes a sub step of performing operation of authenticating said target person by also using the standardized texture information.

18. The authentication method according to claim 13, wherein
said three-dimensional shape information includes three-dimensional coordinate information of a plurality of representative points which are set for an individual model of the face of said target person.

19. The authentication method according to claim 13, wherein
said three-dimensional shape information includes information of a distance between arbitrary two points in a plurality of representative points which are set for an individual model of the face of said target person.

20. The authentication method according to claim 13, wherein
said three-dimensional shape information includes angle information of a triangle formed by arbitrary three points in a plurality of representative points which are set for an individual model of the face of said target person.

21. A computer software program for making a computer execute:
a procedure of acquiring three-dimensional shape information of a face of a target person to be authenticated;
a procedure, when a vector space expressing said three-dimensional shape information is virtually separated into a first subspace in which the influence of a change in facial expression is relatively small and which is suitable for discrimination among persons and a second subspace in which the influence of a change in facial expression is relatively large and which is not suitable for discrimination among persons, of compressing said three-dimensional shape information to three-dimensional shape feature information by using a predetermined mapping relation of transforming an arbitrary vector in said vector space to a vector in said first subspace; and
a procedure of performing an operation of authenticating said target person by using said three-dimensional shape feature information.
